(19) United States
(12) Patent Application Publication
(10) Pub. No.: US 2025/0144934 A1
(43) Pub. Date: May 8, 2025

(54) RECORDING ELEMENT SUBSTRATE AND RECORDING HEAD

(71) Applicant: CANON KABUSHIKI KAISHA, Tokyo (JP)

(72) Inventor: HIROYASU NOMURA, Tokyo (JP)

(21) Appl. No.: 18/929,928

(22) Filed: Oct. 29, 2024

(30) Foreign Application Priority Data
Nov. 8, 2023 (JP) 2023-190538

(51) Int. Cl. B41J 2/14; B41J 2/045

(52) U.S. Cl. CPC B41J 2/14153; B41J 2/04563; B41J 2/0458; B41J 2/04588; B41J 2/14072

(57) ABSTRACT

A recording element substrate is used in which a liquid chamber is formed between a substrate and a channel-formation member. A discharge orifice configured to discharge liquid in the liquid chamber is provided. The substrate includes at least a first layer, and a second layer that is farther away from the liquid chamber than the first layer. A first heater configured to heat and discharge the liquid by application of a drive pulse, and a temperature sensor that is disposed with at least a portion overlapping the liquid chamber in plan view, are provided in the first layer. A second heater that is disposed with at least a portion overlapping the temperature sensor in plan view is provided in the second layer.

### BACKGROUND OF THE INVENTION

### Field of the Invention

The present invention relates to a recording element substrate and a recording head.

### Description of the Related Art

There are recording devices of an inkjet recording system in which ink is discharged from nozzles and made to adhere to a recording medium such as paper or the like. Of these, a system in which ink is discharged from nozzles under thermal energy generated by a heater is referred to as a “thermal ink-jet recording system”. A structure has been proposed in inkjet recording devices that use this system, in which electroconductive plugs are provided at terminal portions of a temperature sensor made up of a thin-film resistor, which is disposed directly below the heater, so as to connect to a wiring layer in a lower layer (Japanese Patent No. 7112287).

In the inkjet recording device described in Japanese Patent No. 7112287, at the time of detecting temperature signals output from the temperature sensor, potential difference is monitored at both terminal portions of the temperature sensor while applying a constant electric current to the temperature sensor through the wiring layer in the lower layer and the electroconductive plug. Employing such a structure does away with the need to provide a wiring layer directly above the temperature sensor, and accordingly the temperature sensor can be brought closer to the heater by an amount equivalent to film thickness of the wiring layer, and the thickness of an inter-layer insulating film between the heater and the temperature sensor can be reduced. Thus, thermal resistance between the heater and the temperature sensor is reduced, and sensitivity of the temperature sensor improves.

However, in Japanese Patent No. 7112287, the temperature sensor is directly below the heater in the first place. Accordingly, even if the temperature sensor is brought closer to the heater, temperature change brought about by the ink needs to be found through the inter-layer insulating film and the heater that are directly above, and there is a limit in improvement in sensitivity thereof.

Accordingly, a system has been proposed in which the heater itself is used as a temperature sensor (Japanese Translation of PCT Application No. 2018-535848). However, in this system, the temperature change in ink could only be found during periods in which electricity is being applied to the heater.

### SUMMARY OF THE INVENTION

Accordingly, in recording devices of thermal inkjet recording systems that heat ink by a heater, there is demand for further improvement in sensitivity of the temperature sensor with regard to temperature change of ink.

The present invention has been made in light of the foregoing circumstances, and accordingly an object thereof is to improve sensitivity of detecting temperature change of ink by a temperature sensor in a recording device of an inkjet recording system.

The present invention provides a recording element substrate including a substrate and a channel-formation member, wherein
a liquid chamber configured to accommodate a liquid is formed between the substrate and the channel-formation member,
a discharge orifice configured to discharge the liquid accommodated in the liquid chamber is provided in the channel-formation member,
the substrate includes at least a first layer, and a second layer that is farther away from a face on which the liquid chamber is formed than the first layer,
a first heater configured to generate heat by application of a drive pulse, and to heat and discharge the liquid from the discharge orifice, and a temperature sensor that is disposed with at least a portion overlapping the liquid chamber in plan view, are provided in the first layer, and
a second heater that is disposed with at least a portion overlapping the temperature sensor in plan view is provided in the second layer.

The present invention provides a recording head, comprising:
a recording element substrate including a substrate and a channel-formation member; and
a control unit configured to control driving of the recording element substrate;
wherein
a liquid chamber configured to accommodate a liquid is formed between the substrate and the channel-formation member,
a discharge orifice configured to discharge the liquid accommodated in the liquid chamber is provided in the channel-formation member,
the substrate includes at least a first layer, and a second layer that is farther away from a face on which the liquid chamber is formed than the first layer,
a first heater configured to generate heat by application of a drive pulse, and to heat and discharge the liquid from the discharge orifice, and a temperature sensor that is disposed with at least a portion overlapping the liquid chamber in plan view, are provided in the first layer, and
a second heater that is disposed with at least a portion overlapping the temperature sensor in plan view is provided in the second layer.

According to the present invention, sensitivity at the time of detecting temperature change of ink by the temperature sensor in the recording device of the inkjet recording system can be improved.

Further features of the present invention will become apparent from the following description of exemplary embodiments with reference to the attached drawings.

### BRIEF DESCRIPTION OF THE DRAWINGS

FIG. 1 is a plan view of one nozzle, as viewed from a discharge direction of ink from a substrate side;

FIG. 2A is a cross-sectional view taken along line A-A on the nozzle in FIG. 1;

FIG. 2B is a cross-sectional view taken along line B-B on the nozzle in FIG. 1;

FIG. 3 is a block diagram of drive circuit for a heater and a temperature sensor output processing circuit;

FIG. 4 is a timing chart showing control by a logic circuit unit;

FIG. 5A is a nozzle cross-sectional schematic view representing tailing of discharged ink during normal discharge;

FIG. 5B is a nozzle cross-sectional schematic view representing tailing of discharged ink during direction-deviated discharge;

FIG. 6A is a timing chart showing output waveforms of a determination circuit unit during normal discharge;

FIG. 6B is a timing chart showing output waveforms of the determination circuit unit during direction-deviated discharge;

FIG. 7 is a block diagram of a drive circuit for a heater and a temperature sensor output processing circuit according to a second embodiment;

FIG. 8 is a timing chart showing control by a logic circuit unit according to the second embodiment;

FIG. 9 is a plan view of one nozzle, as viewed from a discharge direction of ink from a substrate side, according to a third embodiment;

FIG. 10 is a cross-sectional view taken along line A-A on the nozzle in FIG. 9;

FIG. 11 is a plan view of one nozzle, as viewed from a discharge direction of ink from a substrate side, according to a fourth embodiment;

FIG. 12A is a cross-sectional view taken along line A-A on the nozzle in FIG. 11;

FIG. 12B is a cross-sectional view taken along line B-B on the nozzle in FIG. 11;

FIG. 13 is a block diagram of drive circuit for a heater and a temperature sensor output processing circuit according to the fourth embodiment; and

FIG. 14 is a block diagram illustrating a control configuration of a discharge direction deviation inspection device.

### DESCRIPTION OF THE EMBODIMENTS

Preferred embodiments for carrying out the invention will be exemplarily described below in detail with reference to the Figures. Note that the dimensions, materials, shapes, relative placements thereof, and so forth, of components described in the embodiments are not intended to limit the scope of the invention to these alone, unless specifically stated otherwise. Also, materials, shapes, and so forth, of members described once in the description below are the same as the initial description in subsequent descriptions as well, unless specifically stated again. Technology known to the related field, or widely-known technology, can be applied to configurations and processes that are not illustrated or described in particular. Also, repetitive description may be omitted.

### First Embodiment

### Configuration of Inspection Device

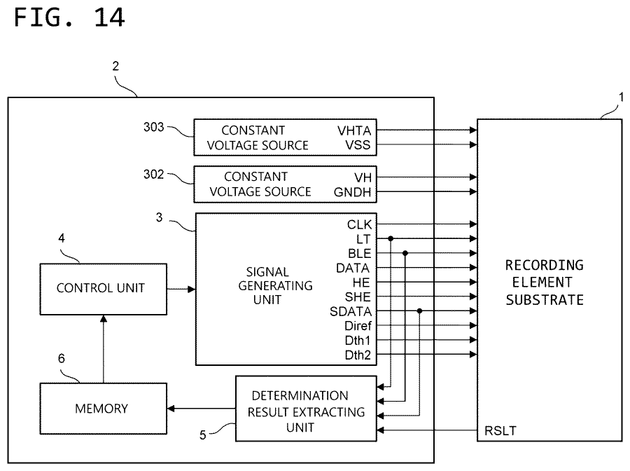

FIG. 14 is a block diagram illustrating a control configuration of a discharge direction deviation inspection device 2, for inspection of so-called discharge direction deviation of ink, in which liquid ink lands in a direction deviated from an axial line of a nozzle.

Upon receiving an instruction from a control unit 4, a signal generating unit 3 outputs, to a recording element substrate 1, a clock signal (CLK), a latch signal (LT), a block signal (BLE), a heater selection signal (DATA), a heat enable signal (HE), and a sub-heat enable signal (SHE). Voltage VH that is applied to a selected heater is supplied to the recording element substrate 1 from a constant voltage source 302. The signal generating unit 3 further outputs a sensor selection signal (SDATA), a constant current signal (Diref), a threshold value signal 1 (Dth1), and a threshold value signal 2 (Dth2), which relate to selection of two temperature sensors provided to each nozzle and amount of electricity applied, and processing of output signals.

Supply of electric power to a constant current generating circuit that the recording element substrate 1 is equipped with is performed by a constant voltage source 303.

Meanwhile, a determination result extracting unit 5 receives a determination result signal (RSLT) output from the recording element substrate 1 on the basis of temperature information detected by the temperature sensor, and extracts a determination result for each latch period, synchronously with a trailing edge of the latch signal LT. When the determination result indicates direction-deviated discharge, the block signal BLE and the sensor selection signal SDATA corresponding to the determination result are then recorded in memory 6.

Upon receiving the block signal BLE and the sensor selection signal SDATA regarding the direction-deviated discharge nozzle recorded in the memory 6, in a case in which a driving object heater includes a direction-deviated discharge nozzle, the control unit 4 deletes the direction-deviated discharge nozzle from the heater selection signal DATA of this block. A nozzle for direction deviation compensation is added to the heater selection signal DATA of this block instead, and output to the signal generating unit 3.

### Recording Element Substrate and Nozzle

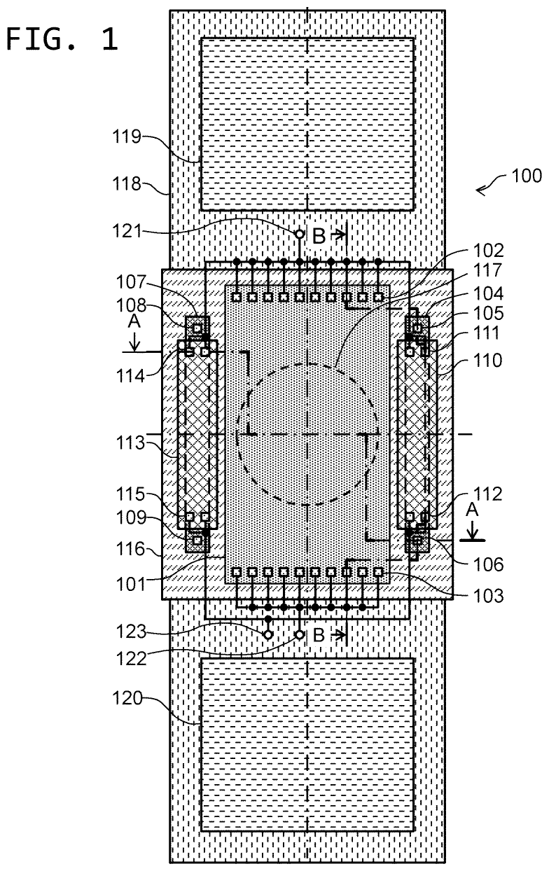

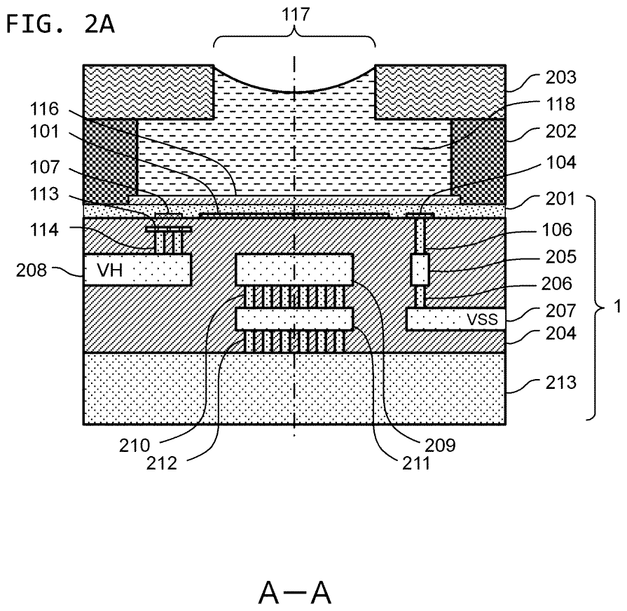

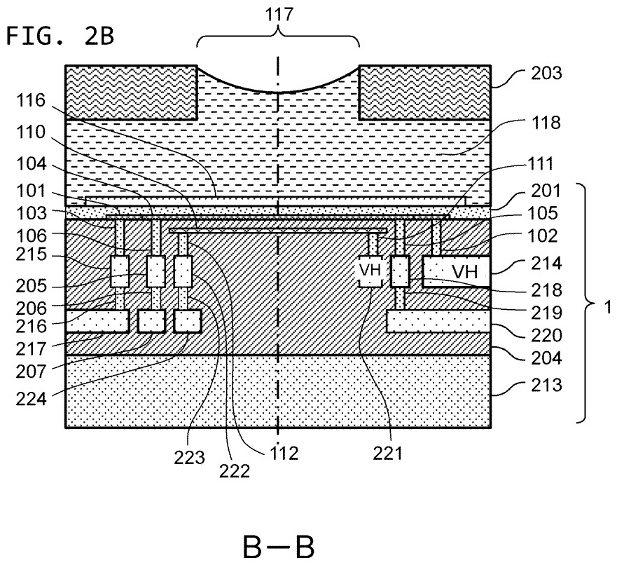

FIG. 1 is a plan view of one nozzle 100 out of a plurality of the nozzles provided in the recording element substrate 1 according to the present embodiment, as viewed from a discharge direction of ink from a substrate side. Also, FIGS. 2A and 2B are cross-sectional views of the nozzle in FIG. 1, with FIG. 2A being a line A-A cross-sectional view, and FIG. 2B a line B-B cross-sectional view. A structure of the nozzle surroundings in the present embodiment will be described below with reference to FIGS. 1, 2A, and 2B.

An ink channel 118 is formed on the recording element substrate 1 for each nozzle, with each ink channel 118 being partitioned by channel partition walls 202. An ink supply port 119 and an ink discharge port 120 are provided in the recording element substrate 1, in a perpendicular direction to a bottom face of the ink channel 118. An orifice plate 203 is disposed on an upper face of the channel partition walls 202. One discharge orifice 117 is formed with respect to one nozzle in the orifice plate 203.

Space defined by the recording element substrate 1, the orifice plate 203, and the channel partition walls 202 makes up a liquid chamber in which liquid (ink) is accommodated. The orifice plate 203 and the channel partition walls 202 function as channel-formation members that form the channel and the liquid chamber, along with the recording element substrate 1. A substrate including a plurality of the liquid chambers formed by the recording element substrate 1 and the orifice plate 203 makes up a recording head of a recording device. The liquid accommodated in each of the plurality of liquid chambers bubbles under heat generated when voltage is applied to a heater 101 disposed corresponding to each liquid chamber, and is discharged from the discharge orifices 117. Accordingly, the liquid chamber is also referred to as a “bubbling chamber”.

A heater 101 that is rectangular and that is made of a thin-film resistor of a material with a high specific resistance and that is thermally stable such as TaSiN, for example, is provided within the recording element substrate 1, directly below the discharge orifice 117.

Further, in the same layer as the layer in which the heater 101 is provided, two temperature sensors 104 and 107 that make up a pair, adjacent to the long sides of the heater 101 in plan view around the middle thereof, are provided substantially symmetrical with respect to the heater 101. Note that in order to raise the sensitivity of the temperature sensors 104 and 107, a material that has, in addition to high specific resistance, a high temperature coefficient of resistance is desirably used. While the expression regarding the arrangement of the pair of temperature sensors being disposed substantially symmetrical here does not have to mean that the shape and layout thereof are rigidly in line symmetry or point symmetry, it is necessary for the pair of temperature sensors to at least be disposed on the other side of the heater 101 from each other.

According to the layout described above, the two temperature sensors 104 and 107 can be provided closest to the heater 101, but the temperature sensors 104 and 107 cannot be brought any closer to the heater 101 beyond a certain distance therefrom, due to short-circuiting prevention, and accordingly the heater 101 is not able to sufficiently heat the temperature sensors alone.

Accordingly, two auxiliary heaters 110 and 113 for heating the temperature sensors via an insulating member 204 are provided in a lower layer of the temperature sensors 104 and 107. That is to say, the auxiliary heater 110 for heating the temperature sensor 104, and the auxiliary heater 113 for heating the temperature sensor 107, are provided.

In some conventional arrangements, a sub-heater, which is omitted from illustration, is disposed between the ink supply port 119 and the discharge orifice 117 in in-plane view, over a plurality of the nozzles in order to maintain heat of ink within the recording element substrate 1. Unlike this sub-heater, the auxiliary heaters 110 and 113 are provided to generate heat over very short periods in the order of sub-microseconds, to heat the temperature sensors 104 and 107, so as to raise the sensitivity of the temperature sensors.

A protective film 201 of an insulator such as SiN, for example, is formed over the heater 101 and the temperature sensors 104 and 107. Farther above that is formed an anti-cavitation film 116 made of Ta, for example, so as to cover the heater 101 and the temperature sensors 104 and 107 in plan view in FIG. 1. Accordingly, the heater 101 and the temperature sensors 104 and 107 are disposed in the same layer (first layer), without overlapping each other in plan view.

As illustrated in FIGS. 1 and 2A, the temperature sensors 104 and 107 are provided at positions overlapping with the ink channel 118 across the protective film 201 and the anti-cavitation film 116. Also, the auxiliary heaters 110 and 113 are provided so as to cover between electroconductive plugs 105, 106, 108, and 109 on both ends of the temperature sensors. In FIG. 1, outlines of the temperature sensors 104 and 107 overlapping the respective auxiliary heaters 110 and 113 are indicated by dashed lines. Thus, the layer including the auxiliary heaters 110 and 113 (second layer) are disposed away from the face of the recording element substrate 1 nearer to the liquid chamber, out of both faces thereof, in comparison with the first layer.

The recording element substrate 1 is made up of a plurality of wiring layers provided in the insulating member 204 on the substrate 213. The insulating member 204 is made up of a plurality of inter-layer insulating films that are stacked, and each of the wiring layers is provided between inter-layer insulating films. A semiconductor material such as silicon or the like is used for the substrate 213, and an insulating material such as silicon oxide or the like is used for the insulating member 204.

The above-described heater 101 and temperature sensors 104 and 107 form a circuit that is capable of executing recording functions, by being electrically connected via the wiring patterns provided in the plurality of wiring layers and the electroconductive plugs. In the present embodiment, two wiring layers are provided, which is a first layer that is closest to the substrate 213, and a second layer that is upward therefrom.

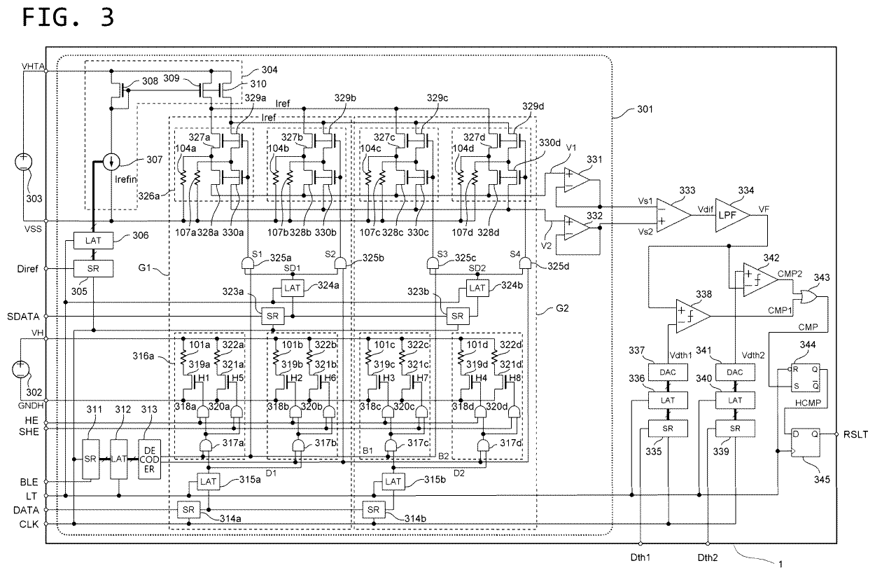

The heater 101 is connected to a wiring pattern 214 in the second layer via an electroconductive plug 102 at one end portion thereof on a short side, connected to a pad 215 in the second layer via an electroconductive plug 103 at the other end portion thereof, and further is connected to a wiring pattern 217 in the first layer via an electroconductive plug 216. Note that the wiring pattern 214 is connected to a constant voltage source, and the wiring pattern 217 is grounded via a switching device 319 (see FIG. 3), which will be described later.

The temperature sensor 104 is connected to a pad 218 in the second layer via the electroconductive plug 105 provided at one end portion thereof, and further is connected to a wiring pattern 220 in the first layer via an electroconductive plug 219, as illustrated in FIG. 2B. The other end portion thereof is connected to a pad 205 in the second layer via the electroconductive plug 106, and further is connected to a wiring pattern 207 in the first layer via an electroconductive plug 206.

Note that the wiring pattern 220 is connected to a constant current source 309 via a switching device 327 (see FIG. 3), which will be described later, and the wiring pattern 207 is grounded. The temperature sensor 107 is connected to predetermined wiring patterns in the same way.

The auxiliary heater 110 is connected to a wiring pattern 221 in the second layer via an electroconductive plug 111 at one end portion thereof, as illustrated in FIG. 2B, and is connected to a pad 222 in the second layer via an electroconductive plug 112 at the other end portion thereof, and further is connected to a wiring pattern 224 in the first layer via an electroconductive plug.

Note that the wiring pattern 221 is connected to the same constant voltage source to which the wiring pattern 214 is connected, and a wiring pattern 223 is grounded via the switching device 319 (see FIG. 3), which will be described later. The auxiliary heater 113 is also connected to predetermined wiring patterns in the same way.

Heavy lines drawn from the electroconductive plugs connecting the heater 101 and the auxiliary heaters 110 and 113 illustrated in FIG. 1 schematically represent the wiring to each wiring layer described above in plan view. In FIG. 1, a terminal 121 represents a connection point of the wiring patterns 214 and 221 and the constant voltage source. Separately, a terminal 122 represents a connection point of the wiring pattern 217 and the switching device 319 (see FIG. 3). Also, a terminal 123 represents a connection point of the wiring pattern 224 and the switching device 319 (see FIG. 3).

Also, downward from the heater 101, a thermal dissipation pattern 209 is disposed in the second layer. The thermal dissipation pattern 209 is connected to a thermal dissipation pattern 211 in the first layer via a plug 210. The thermal dissipation pattern 211 is connected to the substrate 213 via a plug 212. According to this configuration, in a case in which driving is suppressed following the heater 101 being driven and heat being generated, this heat is quickly released to the substrate 213.

### Circuit Block Configuration

FIG. 3 is a block diagram of driving circuits of heaters mounted on the recording element substrate 1, and processing circuits of output signals from the temperature sensors, in the present embodiment. In order to simplify description here, an arrangement will be assumed in which the recording element substrate 1 includes, in a nozzle row 301, each of four heaters 101a to 101d, and eight temperature sensors 104a to 104d and 107a to 107d, which are laid out in the order illustrated in FIG. 3.

The recording element substrate 1 includes a constant current source 304 for power feeding to the temperature sensors 104a to 104d and 107a to 107d, and an input/output unit (pads or terminals) for external input/output of signals and information.

The constant voltage source 302 for driving the heaters 101a to 101d and auxiliary heaters 322a to 322d is connected between a VH pad and a GNDH pad. Also, a constant voltage source 303 for supply of electric power to the constant current source 304 is connected between a VHTA pad and a VSS pad, VHTA of 5 V, for example, is applied to a high-voltage side of the constant current source 304, and a low-voltage side is grounded to VSS as GND.

The constant current source 304 is made up of two systems that are the constant current sources 309 and 310, and current Iref is mirrored in the constant current sources 309 and 310 by a mirroring circuit 308 by the same amplification factor, with a same current-type digital-to-analog converter (DAC) 307 as a reference current source.

A drive circuit 316a is configured as a circuit that controls application of voltage VH of the constant voltage source 302 to the heater 101a and the auxiliary heater 322a. Here, the auxiliary heater 322a is an arrangement in which the auxiliary heaters 110 and 113 that are electrically connected in parallel is expressed as a single auxiliary heater.

When output of gate circuits 317a and 318a both go to High and the switching device 319a goes to on, VH of 24 V, for example, is applied to a high-voltage side of the heater 101a, and a source terminal of the switching device 319a is grounded to GNDH. Voltage application to the auxiliary heater 322a is also controlled by similar switching operations. The three other heaters 101b to 101d and the three other auxiliary heaters 322b to 322d are also controlled by similar switching devices.

The temperature sensors 104a and 107a make up a single temperature acquisition circuit 326a along with switching devices 327a to 330a. The switching device 327a controls power feeding of current of the constant current source 309 to the temperature sensor 104a. Also, the switching device 328a controls output of voltage generated at the temperature sensor 104a to a voltage follower 331. In the same way, a switching device 329a controls power feeding of current of the constant current source 310 to the temperature sensor 107a. Also, the switching device 330a controls output of voltage generated at the temperature sensor 107a to a voltage follower 332.

The switching devices 327a to 330a go on simultaneously, and at this time, the temperature sensors 104a and 107a output temperature signals, for inspecting a direction deviation state of an ink droplet discharged from a nozzle corresponding to the heater 101a, to the voltage followers 331 and 332. The six other temperature sensors 104b to 104d and 107b to 107d are also controlled by similar switching devices.

As described above, the circuit configuration illustrated in FIG. 3 includes four drive circuits 316a to 316d and four temperature acquisition circuits 326a to 326d. Also, the four drive circuits 316a to 316d and the four temperature acquisition circuits 326a to 326d are divided into two groups, which are G1 and G2. Each group is made up of two drive circuits and two temperature acquisition circuits.

### Control Timing

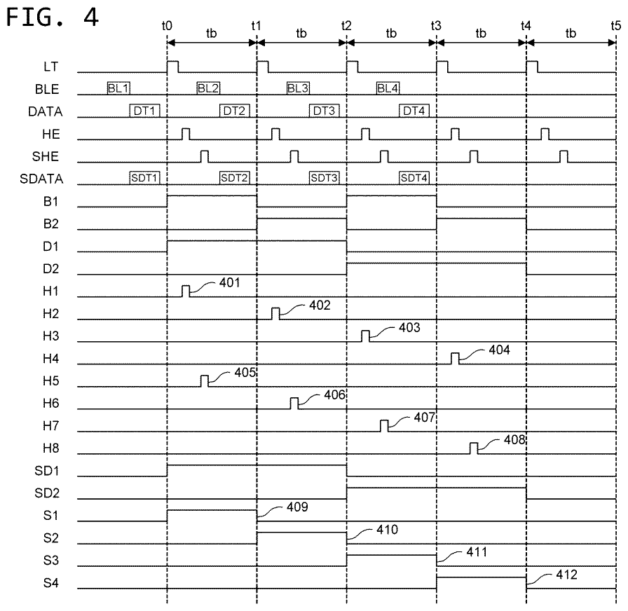

FIG. 4 is a timing chart showing timings of control in a logic circuit unit of the recording element substrate 1. Operations of the logic circuit unit of the recording element substrate 1 according to the present embodiment will be described below with reference to FIGS. 3 and 4.

The recording element substrate 1 receives the clock signal (CLK), the latch signal (LT), the block signal (BLE), the heater selection signal (DATA) that is 2-bit serial data, the heat enable signal (HE), and the sub-heat enable signal (SHE), transferred from the discharge direction deviation inspection device 2. Note that the block signal (BLE) is normally multi-bit serial data, but in the present embodiment is 1-bit data.

The recording element substrate 1 further receives the sensor selection signal (SDATA) that is 2-bit serial data. Signals other than the clock signal (CLK) are received at intervals of a block cycle tb. That is to say, control of the four drive circuits 316a to 316d and the four temperature acquisition circuits 326a to 326d is time-divided into two block periods, which are repeated twice to complete acquisition of temperature signals for the eight temperature sensors 104a to 104d and 107a to 107d.

Block signals BL1 to BL4 are transferred to a shift register 311 synchronously with the clock signal (CLK), latched at a latch circuit 312 at respective timings t0 to t3, decoded at a decoder 313, and output to wirings B1 and B2. Note that in the present embodiment, the shift register 311 is a 1-bit register. Signals of the wirings B1 and B2 are held for the tb until the next latch timing, during which time the next block signal is transferred to the shift register 311.

Signals of the wirings B1 and B2 are signals regarding which only one of the two is enabled, and is used for selecting heaters to be driven simultaneously. In FIG. 3, the wiring B1 is connected to the gate circuits 317a and 317c. Accordingly, when the signal of the wiring B1 is enabled (High active), the heaters 101a and 101c can be driven simultaneously. In the same way, when the signal of the wiring B2 is enabled, the heaters 101b and 101d can be driven simultaneously.

As shown in FIG. 4, in the present embodiment, an arrangement is described in which driving is performed in time division such that B1 is enabled during t0 to t1 and t2 to t3, and B2 is enabled during t1 to t2 and t3 to t4, respectively.

Heater selection signals DT1 to DT4 are transferred to shift registers 314a and 314b synchronously with the clock signal (CLK), latched at latch circuits 315a and 315b at respective timings t0 to t3, and output to the wirings D1 and D2. The signals of the wirings D1 and D2 are held for the tb until the next latch timing, during which time the next selection signals are transferred to the shift registers 314a and 314b.

The signals of the wirings D1 and D2 are used to select the groups G1 and G2 of the heaters. In FIG. 3, the wiring D1 is connected to the gate circuits 317a and 317b. Accordingly, when the signal of the wiring D1 is enabled (High active), the heaters 101a and 101b and the auxiliary heaters 322a and 322b of the group G1 can be selected. In the same way, when the signal of the wiring D2 is enabled, the heaters 101c and 101d and the auxiliary heaters 322c and 322d of the group G2 can be selected. In the present embodiment, an arrangement is described in which the heaters and auxiliary heaters of the group G1 are selected during the two block periods in the first half, and the heaters and auxiliary heaters of the group G2 are selected during the two block periods in the second half. That is to say, driving of all of the four heaters and auxiliary heaters is completed in four block periods.

The signal of the wiring B1 is input to the gate circuit 317a along with the signal of the wiring D1. The output signal of the gate circuit 317a is further input to each of gate circuits 318a and 320a along with the heat enable signal (HE) or the sub-heat enable signal (SHE). The gate circuits 318a and 320a output pulse signals 401 and 405 to respective wirings H1 and H5. The wirings H1 and H5 are respectively connected to switching devices 319a and 321a, and the heater 101a and the auxiliary heater 322a are respectively driven by the pulse signals 401 and 405.

In the same way, pulse signals 402, 403, and 404 are output to respective wirings H2, H3, and H4 by gate circuits 318b, 318c, and 318d. Also, pulse signals 406, 407, and 408 are output to respective wirings H6, H7, and H8 by the gate circuits 320b, 320c, and 320d.

The wirings H2, H3, and H4 are connected to the respective switching devices 319b, 319c, and 319d, and the respective heaters 101b, 101c, and 101d are driven by the pulse signals 402, 403, and 404. Also, the wirings H6, H7, and H8 are connected to the respective switching devices 321b, 321c, and 321d, and the respective auxiliary heaters 322b, 322c, and 322d are driven by the pulse signals 406, 407, and 408.

Sensor selection signals SDT1 to SDT4 are transferred to shift registers 323a and 323b synchronously with the clock signal (CLK), latched at latch circuits 324a and 324b at respective timings t0 to t3, and output to wirings SD1 and SD2. The signals of the wirings SD1 and SD2 are held for the tb until the next latch timing, during which time the next sensor selection signals are transferred to the shift registers 323a and 323b.

The signals of the wirings SD1 and SD2 are used for selecting one group including the temperature sensors corresponding to the heaters and auxiliary heaters to be driven, out of G1 and G2. In FIG. 3, the wiring SD1 is connected to gate circuits 325a and 325b. Accordingly, when the signal of the wiring SD1 is enabled (High active), the temperature sensors 104a, 104b, 107a, and 107b, of the group G1, can be selected as temperature sensors corresponding to the heaters and the auxiliary heaters to be driven. In the same way, when the signal of the wiring SD2 is enabled (High active), the temperature sensors 104c, 104d, 107c, and 107d, of the group G2, can be selected as temperature sensors corresponding to the heaters and the auxiliary heaters to be driven.

As illustrated in FIG. 4, an arrangement is described in the present embodiment in which, out of the four block periods, the signal of the wiring SD1 is enabled and the temperature sensors of the group G1 are selected in the first and second block periods. Also, an arrangement is described in which the signal of the wiring SD2 is enabled and the temperature sensors of the group G2 are selected in the third and fourth block periods.

The signals of the wirings B1 and B2 are diverted for use as the block signals for selecting the temperature sensors. That is to say, along with the signals of the wiring SD1, the signals of the wirings B1 and B2 are input to the gate circuits 325a and 325b, respectively. In the same way, along with the signals of the wiring SD2, the signals of the wirings B1 and B2 are input to the gate circuits 325c and 325d, respectively.

The settings value Diref of the constant current Iref is set as a 5-bit digital value that can be set in 32 stages, and is transferred to a shift register 305 synchronously with the clock signal CLK. The constant current Iref is then latched at a latch circuit 306 synchronously with the latch signal LT, and is output to the digital-to-analog converter (DAC) 307 that is a current-output type.

That is to say, the DAC 307 outputs an output current Irefin on the basis of the settings value Diref. The output signal of the latch circuit 306 is held for the tb until the next latch timing, during which time the next settings value Diref is transferred to the shift register 305. The output current Irefin of the DAC 307 is mirrored in the constant current sources 309 and 310, amplified to 12 times, for example, and is output as the constant current Iref.

Thus, in a first block period, a pulse signal 409 that is enabled during t0 to t1 is output from the gate circuit 325a to wiring S1. The wiring S1 is connected to the switching devices 327a and 328a, and power feeding of the constant current Iref is performed from the constant current source 309 to the temperature sensor 104a by the pulse signal 409 during t0 to t1.

Resistance Rs1 of the temperature sensor 104a at temperature T1 is expressed by the following Expression (1)

$$[ Math . 1 ]$$

$$Rs 1 = Rs 0 \cdot \{ 1 + TCR \cdot ( T 1 - T 0 ) \} \qquad ( 1 )$$

where T0 represents normal temperature, Rs0 represents resistance at that time, and TCR represents temperature coefficient of resistance of the temperature sensor 104a.

A temperature signal Vs1 that is generated at a constant-current power-feed-side terminal of the temperature sensor 104a is expressed by the following Expression (2).

$$[ Math . 2 ]$$

$$Vs 1 = Iref \cdot Rs 1 = Iref \cdot Rs 0 \cdot \{ 1 + TCR \cdot ( T 1 - T 0 ) \} \qquad ( 2 )$$

The temperature signal Vs1 expressed by the above Expression (2) is output to the voltage follower 331 through wiring V1.

Also, the wiring S1 is also connected to the switching devices 329a and 330a, and power feeding of the constant current Iref is performed from the constant current source 310 to the temperature sensor 107a by the pulse signal 409 during t0 to t1.

Resistance Rs2 of the temperature sensor 107a at temperature T2 is expressed by the following Expression (3).

$$[ Math . 3 ]$$

$$Rs 2 = Rs 0 \cdot \{ 1 + TCR \cdot ( T 2 - T 0 ) \} \qquad ( 3 )$$

A temperature signal Vs2 that is generated at a constant-current power-feed-side terminal of the temperature sensor 107a is expressed by the following Expression (4).

$$[ Math . 4 ]$$

$$Vs 2 = Iref \cdot Rs 2 = Iref \cdot Rs 0 \cdot \{ 1 + TCR \cdot ( T 2 - T 0 ) \} \qquad ( 4 )$$

The temperature signal Vs2 expressed by the above Expression (4) is output to the voltage follower 332 through wiring V2.

In the present embodiment, a configuration is made in which the normal temperature resistance values of the temperature sensors 104a and 107a are the same Rs0, but the normal temperature resistance values may be different. In this case, the constant current value of power feeding performed to the temperature sensors 104a and 107a is adjusted at the constant current sources 309 and 310 such that the temperature signals Vs1 and Vs2 at normal temperature T0 are equal.

During the second block period, the temperature signals Vs1 and Vs2 generated at the respective constant-current power-feed-side terminals of the temperature sensors 104b and 107b are respectively output to the voltage followers 331 and 332 through the wiring V1 and V2 during t1 to t2, in the same way as in the first block period.

During a third block period, the temperature signals Vs1 and Vs2 generated at the respective constant-current power-feed-side terminals of the temperature sensors 104c and 107c are respectively output to the voltage followers 331 and 332 through the wiring V1 and V2 during t2 to t3, in the same way as in the first and second block periods.

During the fourth block period, the temperature signals Vs1 and Vs2 generated at the respective constant-current power-feed-side terminals of the temperature sensors 104d and 107d are respectively output to the voltage followers 331 and 332 through the wiring V1 and V2 during t3 to t4, in the same way as in the first to third block periods.

Note that when directly inputting the temperature signals Vs1 and Vs2 to a differential amplifier 333, the resistance of the switching devices affects input impedance of the differential amplifier 333, and the temperature signals Vs1 and Vs2 will be input to the differential amplifier 333 with a voltage drop. Accordingly, the temperature signals Vs1 and Vs2 are temporarily received by the voltage followers 331 and 332 disposed within the nozzle row 301, and then input to the differential amplifier 333.

In each of the first to fourth block periods, the differential amplifier 333 outputs a signal Vdif expressed by the following Expression (5), in which a signal obtained by subtracting the temperature signal Vs1 expressed by Expression (2) from the temperature signal Vs2 expressed by Expression (4) is multiplied by an amplification factor Gdif of the differential amplifier, and also offset by voltage Vofs.

$$[ Math . 5 ]$$

$$Vdif = Gdif \cdot ( Vs 2 - Vs 1 ) + Vofs = Vofs - Gdif \cdot Iref \cdot Rs 0 \cdot TCR \cdot ( T 2 - T 1 ) \qquad ( 5 )$$

Two types of noise are cancelled out by this differential amplifier 333. One is noise that is superimposed on the temperature signals Vs1 and Vs2 in proportion to the constant current Iref shown in Expressions (2) and (4), due to current fluctuation at the reference current source 307. Another is crosstalk noise due to voltage fluctuation on wiring intersecting the wirings V1 and V2 via parasitic capacitance. Residual noise in the signal Vdif other than noise described above is suppressed by a low-pass filter 334, and the resulting signal is output as signal VF.

Whether discharge direction deviation is occurring is determined by comparing the signal VF with threshold value voltages Vdth1 and Vdth2, based on two threshold value signals Dth1 and Dth2. That is to say, the signal VF is input to a positive terminal of a comparator 338, and comparison is performed with the threshold value voltage Vdth1 input to a negative terminal thereof. In a case in which VF>Vdth1 holds, a high-level (direction-deviated discharge) signal is output to wiring CMP1, and in a case in which VF≤Vdth1 holds, a low-level (normal discharge) signal is output thereto.

Conversely, the signal VF is input to a negative terminal of a comparator 342, and comparison is performed with the threshold value voltage Vdth2 input to a positive terminal. In a case in which Vdth2>VF holds, a high-level (direction-deviated discharge) signal is output to wiring CMP2, and in a case in which Vdth2≤VF holds, a low-level (normal discharge) signal is output thereto.

The threshold value voltages Vdth1 and Vdth2 can be set in 256 ranks, from 0.5 V to 2.54 V, in 8 mV increments, for example. The setting values Dth1 and Dth2 of the threshold value voltages Vdth1 and Vdth2 are set as 8-bit digital values that can be set in 256 ranks, for example, and are transferred from the signal generating unit 3 to respective shift registers 335 and 339, synchronously with the clock signal CLK. The threshold value signal Dth1 is latched at a latch circuit 336 synchronously with the latch signal LT, and is output to a DAC 337 that is a voltage-output type.

The output signal of the latch circuit 336 is held until the next latch timing, during which time the next threshold value signal Dth1 is transferred to the shift register 335. In the same way, the threshold value signal Dth2 is latched at a latch circuit 340 synchronously with the latch signal LT, and is output to a DAC 341 that is a voltage-output type. The output signal of the latch circuit 340 is held until the next latch timing, during which time the next threshold value signal Dth2 is transferred to the shift register 339.

Signals CMP1 and CMP2 are input to an OR gate circuit 343 and output to wiring CMP. By inputting signal CMP to a set input terminal of a Reset-Set (RS) latch circuit 344, a pulse signal of the signal CMP is output to wiring HCMP while maintained at high-level. Latching this signal HCMP by a flip-flop circuit 345 triggered by the latch signal LT yields a determination result signal RSLT that is high-level in the next latch period if direction-deviated discharge is occurring. The signal HCMP is reset at the trailing edge of the latch signal LT by an inverse signal of the latch signal LT being input to a reset input terminal of the RS latch circuit 344.

The determination result signal RSLT is extracted at the determination result extracting unit 5 illustrated in FIG. 14, synchronously with the trailing edge of the latch signal LT, along with the block signal BLE and the sensor selection signal SDATA that are delayed by an amount of time equivalent to the latch period.

Although a configuration has been described in the present embodiment in which a determination circuit unit from the differential amplifier 333 to the flip-flop circuit 345 described above is provided inside the recording element substrate 1 outside of the nozzle row 301, this may be provided in a control chip provided to the recording head outside of the recording element substrate 1. Also, the determination circuit unit may be provided in a control chip provided to the recording device outside of the recording head.

### Nozzle Cross-section and Output Waveform at Time of Discharge

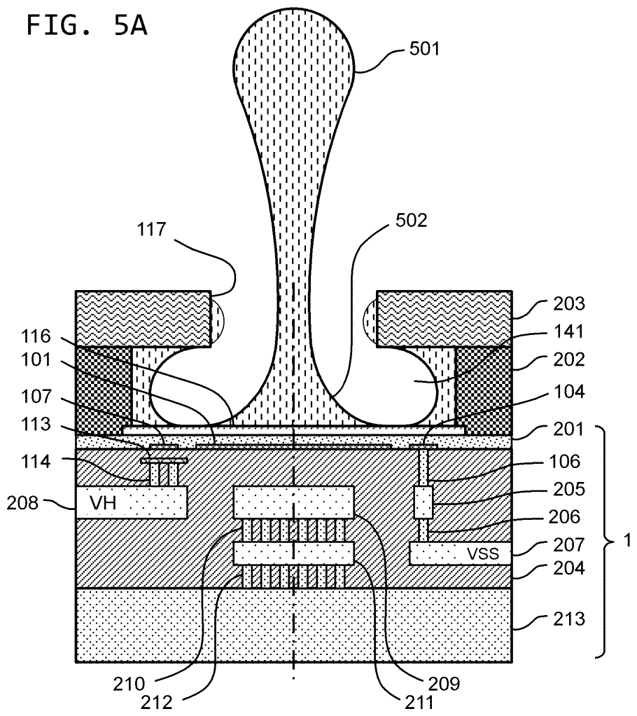

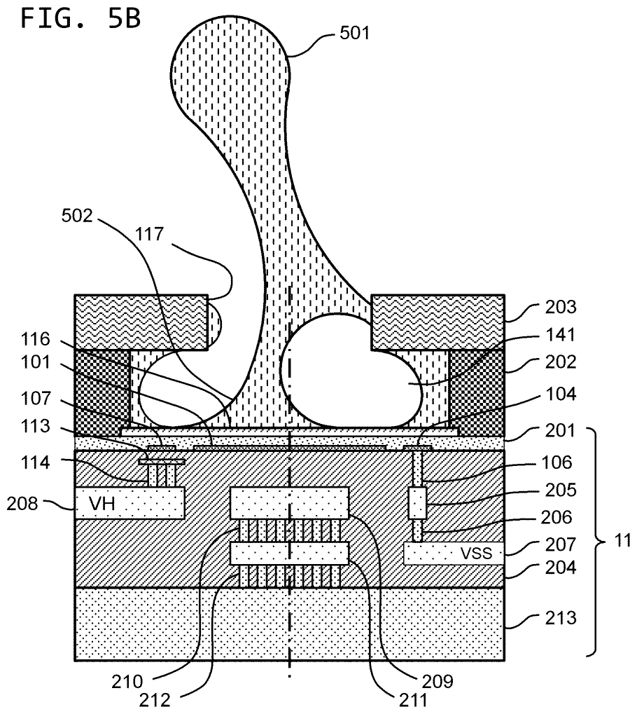

FIGS. 5A and 5B are nozzle cross-sectional schematic views representing a state in which an ink droplet 501 is being discharged from the discharge orifice 117, and a tailing 502 falling on the anti-cavitation film 116, in which FIG. 5A represents normal discharging, and FIG. 5B represents direction-deviated discharging.

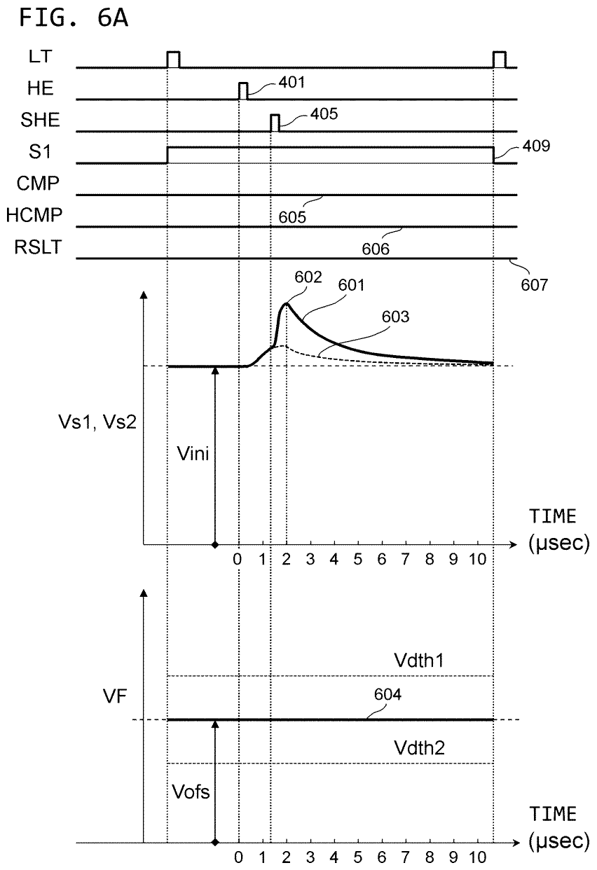

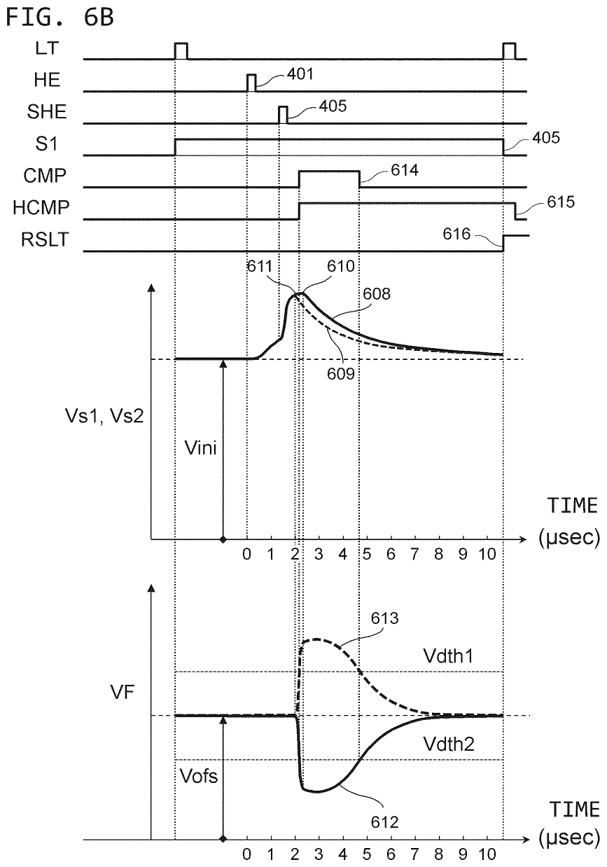

Also, FIGS. 6A and 6B are timing charts showing output waveforms of the determination circuit unit of the recording element substrate 1 during the first block period shown in FIG. 4, in which FIG. 6A represents normal discharging, and FIG. 6B represents direction-deviated discharging. The timing charts are the same for other block periods as well, and accordingly will be omitted from description in the present embodiment.

Difference in operations of the determination circuit unit between normal discharging and direction-deviated discharging in the first block period according to the present embodiment will be described below, with reference to FIGS. 5A, 5B, 6A, and 6B.

FIG. 5A is a nozzle cross-sectional schematic view representing normal discharging, in which the ink droplet 501 is discharged perpendicular to the surface of the orifice plate 203. Also, internal negative pressure of an air bubble 141 generated by bubbling acts symmetrically on the tailing 502, communication of the air bubble 141 with the ambient air due to rupturing of a meniscus also occurs simultaneously over the entire perimeter of the discharge orifice 117, and the tailing 502 falls to the center of the heater 101 in plan view.

Accordingly, the tailing 502 that has fallen spreads symmetrically with respect to the heater 101 in plan view, and accordingly the temperature sensors 104 and 107 disposed symmetrically with respect to the heater 101 are uniformly cooled by the tailing 502. Accordingly, as shown in FIG. 6A, the output signals Vs1 and Vs2 of the temperature sensors 104 and 107 appear to be overlaid on each other, as indicated by waveform 601.

Note that the waveform 601 gradually rises from an initial voltage Vini due to heating by the heater 101 to which the drive pulse 401 is applied. The waveform 601 then rapidly rises due to heating from directly below the temperature sensors by the auxiliary heaters 110 and 113 to which the drive pulse 405 is applied, and the temperature rapidly begins to fall from a feature point 602, due to cooling by the falling of the tailing 502.

If no heating by the auxiliary heaters 110 and 113 were to be performed, gradual rising due to heating by the heater 101 would continue, as in waveform 603, and then the temperature would gradually fall due to cooling by the tailing 502 falling. Accordingly, performing heating by the auxiliary heaters 110 and 113 yields higher sensitivity of the temperature sensors 104 and 107 with respect to falling of the tailing.

The output signals Vs1 and Vs2 are the same (T1=T2), and accordingly, from Expression (5), the output signals Vs1 and Vs2 are cancelled out including the current fluctuation noise and the crosstalk noise, and the output signal Vdif of the differential amplifier 333 is constant voltage Vofs. Accordingly, the output signal VF of the low-pass filter 334 is waveform 604 of the constant voltage Vofs, as shown in FIG. 6A as well.

The threshold value voltages Vdth1 and Vdth2 are set so as to be equidistant with respect to this Vofs, thereabove and therebelow. In FIG. 6A, Vdth2≤VF≤ Vdth1, and accordingly both signals CMP1 and CMP2 are low level (normal discharge), the output signal CMP of the OR gate circuit 343 is also low level, and no pulse is generated (605). Accordingly, the signal HCMP (606) and the determination result signal RSLT (607) are also output to the determination result extracting unit 5 at low level (normal discharge).

Conversely, FIG. 5B is a nozzle cross-sectional schematic view representing direction-deviated discharging, in which the ink droplet 501 is in a state of being discharged deviated to the left side in the plane of the drawing, as compared to the discharge direction in FIG. 5A. Also, the internal negative pressure of the air bubble 141 generated by bubbling acts asymmetrically on the tailing 502, communication of the air bubble 141 with the ambient air also occurs asymmetrically from a spot where the meniscus becomes thin, and consequently the tailing 502 falls deviated to the left side of the heater 101 from the center thereof.

Accordingly, the tailing 502 that has fallen is closer to the temperature sensor 107 in plan view as compared to that in FIG. 5A, and is farther away from the temperature sensor 104, and accordingly the temperature sensor 107 is more strongly cooled by the tailing 502 than the temperature sensor 104.

That is to say, as shown in FIG. 6B, a feature point 610 that appears in waveform 608 of the output signal Vs1 of the temperature sensor 104 is delayed in appearance timing as compared to a feature point 611 that appears in waveform 609 of the output signal Vs2 of the temperature sensor 107. Also, a temperature falling rate, from the feature point 610 and thereafter, is slower as compared to the temperature falling rate from the feature point 611 and thereafter, and the slope of the waveform is gradual.

It should be noted, however, that the difference in emergence time between the feature point 610 and the feature point 611 is slight, extracting the emergence timing of the feature points 610 and 611 requires a separate circuit such as a differentiation filter or the like, and moreover precision is low, and accordingly the difference in emergence time cannot be detected with suitable precision.

Meanwhile following the feature point 611, the waveform 609 of the output signal Vs2 is stably lower than the waveform 608 of the output signal Vs1, and accordingly the signal Vdif obtained by finding the differential of the output signals of the waveforms 608 and 609 and performing amplification thereof can be stably detected with suitable precision. Thus, determination of a state of direction-deviated discharge is performed on the basis of the signal Vdif.

From Expression (5), the output signal Vdif of the differential amplifier 333 drops from the constant voltage Vofs following the feature point 611. Accordingly, the output signal VF of the low-pass filter 334 also becomes a waveform 612 that drops from the constant voltage Vofs following the feature point 611, as shown in FIG. 6B. In FIG. 6B, in a section in which Vdth2>VF holds, signal CMP1 is low level while signal CMP2 is high level (direction-deviated discharge), the output signal CMP of the OR gate circuit 343 is high level (direction-deviated discharge), and pulse 614 is generated. Accordingly, a pulse 615 that holds a pulse 614 is generated in the signal HCMP, and the determination result signal RSLT (616) is output to the determination result extracting unit 5 at high level (direction-deviated discharge).

In a case in which the discharge direction of the ink droplet 501 is deviated to the right side, which is the opposite direction from the direction illustrated in FIG. 5B, the waveform 608 and the waveform 609 in FIG. 6B are switched, and the signal VF becomes a waveform 613 that is the waveform 612 inverted with respect to the constant voltage Vofs.

In this case, in a section in which VF>Vdth1 holds, signal CMP1 is high level (direction-deviated discharge) while signal CMP2 is low level, the output signal CMP of the OR gate circuit 343 is high level (direction-deviated discharge), and the pulse 614 is generated in the same way as with the case of deviating to the left side.

Accordingly, the pulse 615 that holds the pulse 614 is generated in the signal HCMP, and the determination result signal RSLT (616) is output to the determination result extracting unit 5 at high level (direction-deviated discharge).

At the time of heating the temperature sensors by the auxiliary heaters, there is a need to adjust the amount of heat generated, so as not to cause bubbling of ink on an interface of the anti-cavitation film 116 directly above the auxiliary heaters.

Now, with heating length of the heater 101 as Lm, sheet resistance thereof as Rshm, and heat generation density thereof as Qm, and similarly with heating length of the auxiliary heaters 110 and 113 as Ls, sheet resistance thereof as Rshs, and heat generation density thereof as Qs, heating length ratio r of the heaters, sheet resistance ratio γ thereof, and heat generation density ratio κ2 thereof, can be expressed as in the following Expressions (6) to (8).

$$[ Math . 6 ]$$

$$r = \frac{{L}_{m}}{{L}_{s}} \qquad ( 6 )$$

$$γ = \frac{{Rsh}_{m}}{{Rsh}_{s}} \qquad ( 7 )$$

$${κ}^{2} = \frac{{Q}_{m}}{{Q}_{s}} \qquad ( 8 )$$

At this time, a relation expressed in the following Expression (9) holds among the heating length ratio r, the sheet resistance ratio γ, and the heat generation density ratio κ2.

$$[ Math . 7 ]$$

$${κ}^{2} = \frac{1}{γ \cdot {r}^{2}} \qquad ( 9 )$$

Now, with Ls being 60% of Lm, auxiliary heater films being the same material and the same thickness as the heater film, and γ=1, the generation density ratio κ2 is 0.36 from Expression (9). The auxiliary heaters 110 and 113 are farther away from the ink interface than the heater 101, and accordingly assumption will be made that no bubbling occurs at the ink interface directly above the auxiliary heaters as long as the amount of heat generated per unit area of the auxiliary heaters is the same as that of the heater 101. Hence, setting the pulse width of the drive pulse 405 to be 0.36 times the pulse width of the drive pulse 401, since κ2=0.36, the amount of heat generated per unit area of the auxiliary heaters will be the same as that of the heater 101, and adjustment of the amount of heat generated can be performed such that there is no bubbling at the ink interface directly above the auxiliary heaters.

As described above, a configuration is made in the present embodiment in which two temperature sensors are disposed symmetrically in plan view in the same layer as a heater provided to a nozzle, and also two auxiliary heaters are each provided in a lower layer from the temperature sensors, to heat the two temperature sensors. A configuration is further made in which the heater and the auxiliary heaters can each be driven independently by separate drive pulses.

Accordingly, driving the auxiliary heaters following the driving of the heater and also before the falling of the tailing enables the sensitivity of the temperature sensors to be raised with respect to falling of the triality without affecting discharge of the ink droplet, and the degree of direction-deviated discharge of the ink droplet to be detected with high precision. Also, the amount of heat generated by the auxiliary heaters can be adjusted simply by adjusting the pulse width of the drive pulses to be applied to the auxiliary heaters.

### Second Embodiment

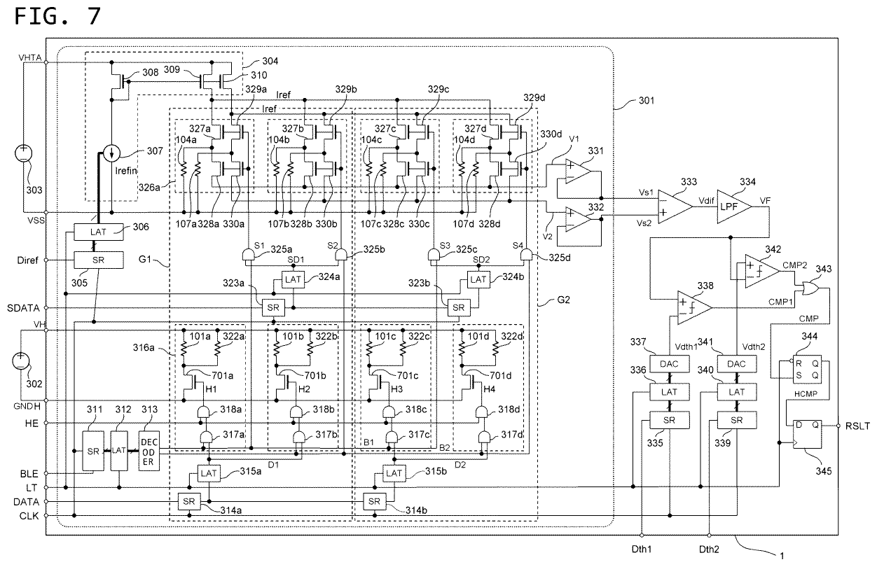

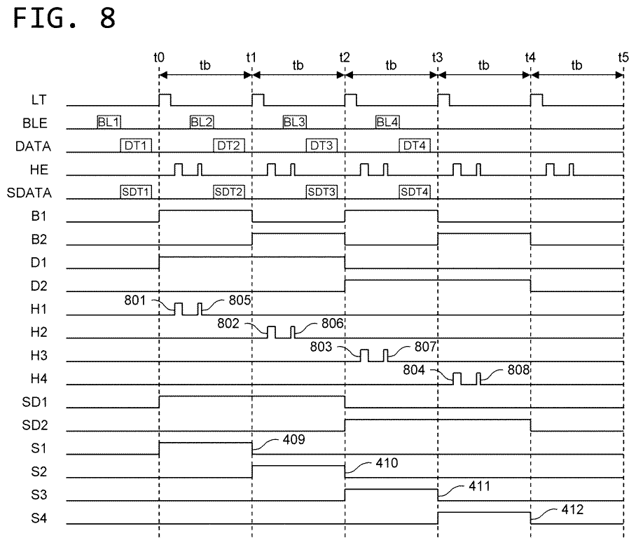

A second embodiment of the present invention will be described below. FIG. 7 is a block diagram of a drive circuit for a heater and a processing circuit for output signals from temperature sensors implemented in the recording element substrate 1 according to the present embodiment. Also, FIG. 8 is a timing chart showing timing of control by a logic circuit unit in the recording element substrate 1 according to the present embodiment.

As illustrated in the block diagram of FIG. 3, the heater 101 and the auxiliary heaters 322 were each individually driven by the switching device 319 and the switching device 321 in the first embodiment. Conversely, a configuration is made in the present embodiment in which driving is performed collectively by a switching device 701, as illustrated in FIG. 7. According to this configuration, one heater drive signal HE will suffice, whereas the two of HE and SHE were necessary, and further, the count of switching devices per nozzle will suffice with one, whereas two were necessary, thereby enabling the drive circuit to be simplified and the size of the recording element substrate 1 to be reduced.

Due to collective driving by the switching device 701, drive pulses 801 to 804 for discharging, shown in FIG. 8, are also applied to the auxiliary heater 322 at the same time as being applied to the heater 101. Heating of the auxiliary heater 322 by the drive pulses 801 to 804 does not contribute to discharging of ink droplets, but has the effect of preheating the temperature sensors 104 and 107.

According to the above-described preheating effects, sufficient heating can be obtained by drive pulses 805 to 808 for heating the temperature sensors, which are pulses that are shorter than the drive pulses 405 to 408. However, the total amount of heat generated at the auxiliary heaters from the drive pulses 801 to 804 and the drive pulses 805 to 808 is greater than the amount of heat generated at the auxiliary heaters from the drive pulses 405 to 408 alone.

Meanwhile, while heating of the heater 101 by the drive pulses 805 to 808 contributes to the heating of the auxiliary heater 322 to a certain degree, the tailing 502 is heated before the tailing 502 that is fallen reaches upper faces of the temperature sensors 104 and 107.

Accordingly, the difference in temperature between the temperature of the tailing 502 when the tailing 502 reaches the upper faces of the temperature sensors 104 and 107 and the temperature of the temperature sensors 104 and 107 is narrowed as compared to the arrangement in the first embodiment, and accordingly the effects of cooling the temperature sensors 104 and 107 by the tailing 502 is somewhat weakened. Accordingly, the sensitivity of the temperature sensors 104 and 107 with respect to the tailing 502 is somewhat weakened as compared to that in the first embodiment.

Now, assuming that no bubbling occurs at the ink interface directly above the auxiliary heaters as long as the amount of heat generated per unit area of the auxiliary heaters by the drive pulses 801 to 804 is the same as that of the heater 101, the generation density ratio κ2 is 1. Setting the heating length ratio r of the heater to 1/0.6, which is the same as that in the first embodiment, yields sheet resistance ratio γ of 0.36 from Expression (9).

Assuming that the material of the heater film and of the auxiliary heater films is the same, a sheet resistance ratio γ of 0.36 can be realized by the film thickness of the auxiliary heaters being 0.36 times that of the film thickness of the heater. If the film thickness is the same, a material of which the specific resistance of the auxiliary heater films is 1/0.36=2.78 times the specific resistance of the heater needs to be selected.

### Third Embodiment

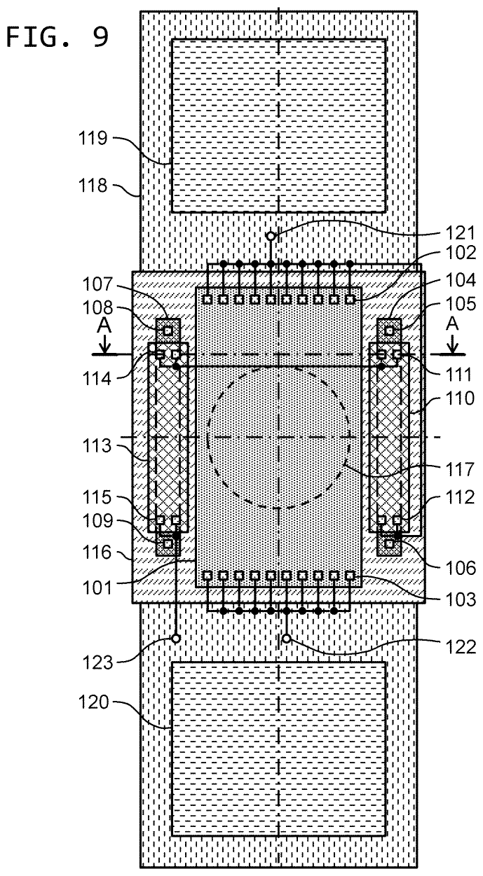

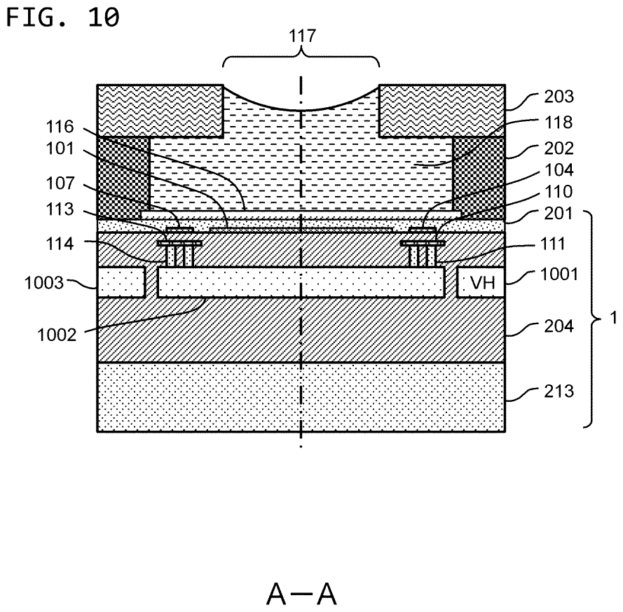

A third embodiment of the present invention will be described below. FIG. 9 is a plan view of one nozzle out of a plurality of nozzles provided in the recording element substrate 1 according to the present embodiment, as viewed from the substrate side in the discharge direction of ink. Also, FIG. 10 is a line A-A cross-sectional view of the nozzle in FIG. 9. Note that for the drive circuit for the heater 101 and the auxiliary heaters 110 and 113 in the present embodiment, the drive circuit illustrated in FIG. 7 is used, the same as that in the second embodiment. Differences with respect to the second embodiment will be described below with reference to FIGS. 9 and 10.

In the second embodiment, the heater 101 and the auxiliary heaters 110 and 113 are connected electrically in parallel as illustrated in FIG. 1, and turning the switching device 701 on applies voltage VH from the constant voltage source 302.

At this time, in a case in which the heater film and the auxiliary heater film are made of the same material, the film thickness of the auxiliary heaters needs to be reduced to 0.36 times that of the film thickness of the heater in order to suppress bubbling at the ink interface directly above the auxiliary heaters, as described in the second embodiment.

However, reducing the film thickness of the auxiliary heaters to 0.36 times the film thickness of the heater results in film formation of the auxiliary heaters being performed in a shorter time than the heater, and there has been a problem in that variance in resistance value due to variance in film thickness increases.

Accordingly, in the present embodiment, the auxiliary heaters 110 and 113 are connected electrically in series via the electroconductive plug 111, a wiring pattern 1002 in the second layer, and an electroconductive plug 114, as illustrated in FIGS. 9 and 10.

Connecting the auxiliary heaters 110 and 113 in series doubles the heating length of the auxiliary heaters, to 1.2 times the heating length of the heater 101. Accordingly, the heating length ratio r of the heaters is 1/1.2, and with the heat generation density ratio κ2 as 1, the sheet resistance ratio γ is 1.44 from Expression (9).

From the above, in a case in which the heater film and the auxiliary heater film are made of the same material, it is sufficient for the film thickness of the auxiliary heaters to be 1.44 times the film thickness of the heater, which enables film formation of auxiliary heaters with smaller variance in resistance values of the heaters.

### Fourth Embodiment

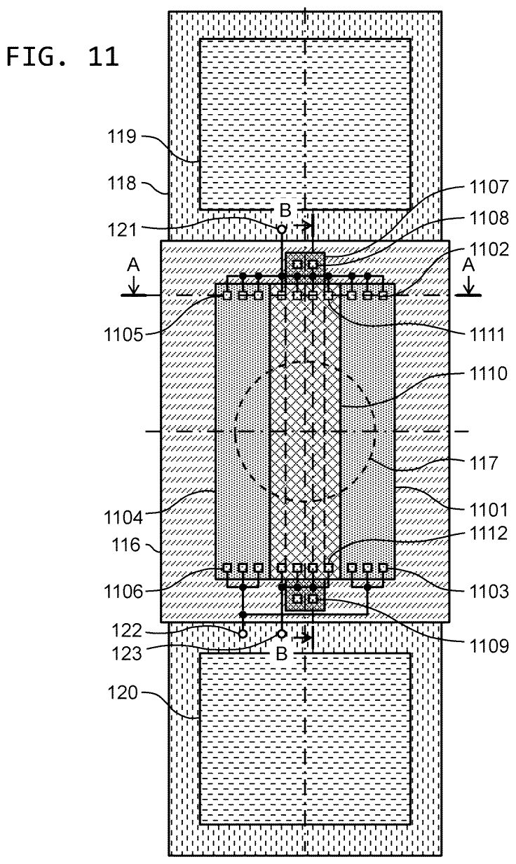

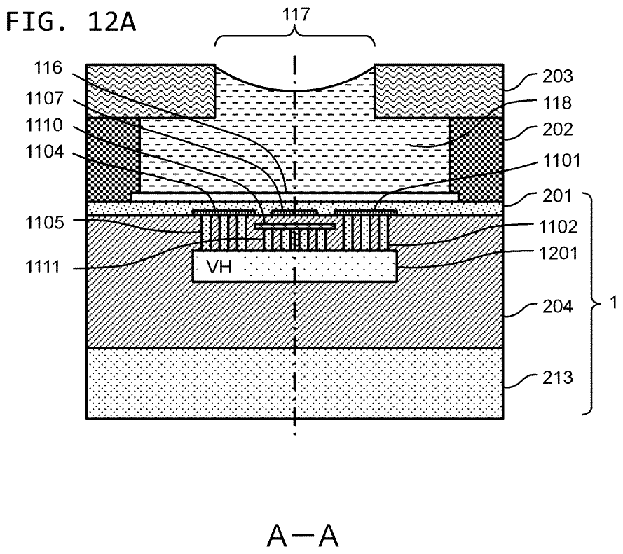

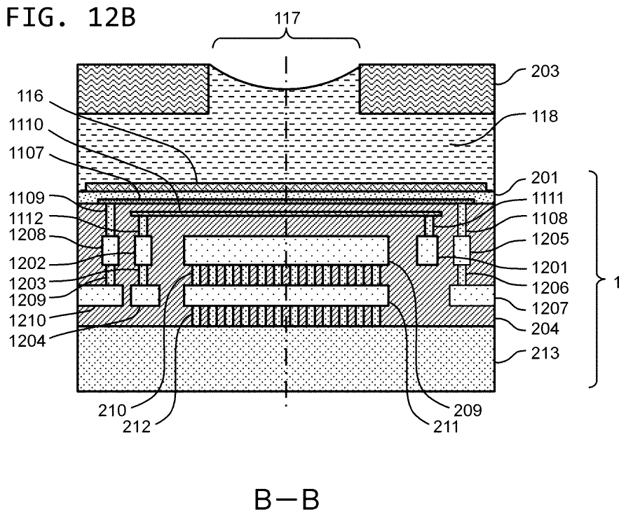

A fourth embodiment of the present invention will be described below. FIG. 11 is a plan view of one nozzle out of a plurality of nozzles provided in the recording element substrate 1 according to the present embodiment, as viewed from the substrate side in the discharge direction of ink. Also, FIGS. 12A and 12B are cross-sectional views of the nozzle in FIG. 1, with FIG. 12A being a line A-A cross-sectional view, and FIG. 12B a line B-B cross-sectional view. A structure of the nozzle surroundings in the present embodiment will be described below with reference to FIGS. 11, 12A, and 12B.

In the present embodiment, a temperature sensor 1107 is disposed at the middle of the nozzle in in-plane view, in order to maximize sensitivity with regard to the tailing 502 that has fallen to the anti-cavitation film 116. Heaters 1101 and 1104 are disposed in the same layer as the temperature sensor 1107, so as to be symmetrical across the temperature sensor 1107.

The temperature sensor 1107 is heated to a certain extent by driving the heaters 1101 and 1104, but this is insufficient, and an auxiliary heater 1110 for heating the temperature sensor is provided in a lower layer of the temperature sensor 1107 via the insulating member 204. The auxiliary heater 1110 is also driven to supplement driving of the heaters 1101 and 1104 in conjunction with discharging ink droplets.

As illustrated in FIG. 12A, the heaters 1101 and 1104, and the auxiliary heater 1110, are connected at one end portion of a short side thereof, to a common wiring pattern 1201 in the second layer, via respective electroconductive plugs 1102, 1105, and 1111.

As illustrated in FIG. 12B, the auxiliary heater 1110 is connected, at the other end portion thereof, to a pad 1202 in the second layer via an electroconductive plug 1112, and further is connected to a wiring pattern 1204 in the first layer, via an electroconductive plug 1203.

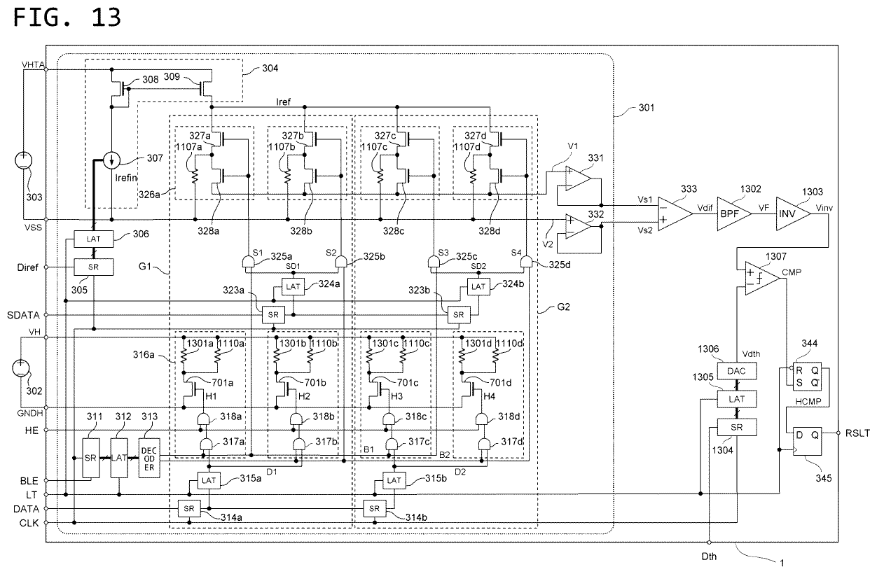

Note that the wiring pattern 1201 is connected to the constant voltage source 302, and the wiring pattern 1204 is grounded via the switching device 701 (see FIG. 13), which will be described later.

The temperature sensor 1107 is connected to a pad 1205 in the second layer, via an electroconductive plug 1108 provided on one end portion thereof, and further is connected to a wiring pattern 1207 in the first layer, via an electroconductive plug 1206. The other end portion thereof is connected to a pad 1208 in the second layer via an electroconductive plug 1109, and further is connected to a wiring pattern 1210 in the first layer via an electroconductive plug 1209. Note that the wiring pattern 1207 is connected to the constant current source 309 via the switching device 327 (see FIG. 13), which will be described later, and the wiring pattern 1210 is grounded.

Heavy lines drawn from the electroconductive plugs connecting the heaters 1101 and 1104, and the auxiliary heater 1110 illustrated in FIG. 11 schematically represent the wiring to each wiring layer described above in plan view.

In FIG. 11, the terminal 121 represents a connection point of the wiring pattern 1201 and the constant voltage source 302. Separately, the terminal 122 represents a connection point of the wiring pattern connecting electroconductive plugs 1103 and 1106 and the switching device 701 (see FIG. 13). Also, the terminal 123 represents a connection point of the wiring pattern 1204 and the switching device 701 (see FIG. 13).

FIG. 13 is a block diagram of driving circuits of heaters mounted on the recording element substrate 1, and processing circuits of output signals from the temperature sensors, in the present embodiment.

The drive circuit 316a is configured as a circuit that controls application of voltage VH of the constant voltage source 302 to a heater 1301a and an auxiliary heater 1110a.

Here, the heater 1301a is an arrangement in which the heaters 1101 and 1104 that are electrically connected in parallel is expressed as a single heater. The auxiliary heater 1110a is also driven for supplementing driving of the heater 1301a in conjunction with discharge of ink droplets, and accordingly a configuration is made in which the heater 1301a and the auxiliary heater 1110a are collectively driven by the switching device 701a, in the same way as the drive circuit illustrated in FIG. 7. The other three heaters 1301b to 1301d and three auxiliary heaters 1110b to 1110d are also controlled by similar switching devices.

The temperature sensor 1107a make up the single temperature acquisition circuit 326a along with the switching devices 327a and 328a. The switching device 327a controls power feeding of current of the constant current source 309 to the temperature sensor 1107a. Also, the switching device 328a controls output of voltage generated at the temperature sensor 1107a to the voltage follower 331.

The switching devices 327a and 328a go on simultaneously, and at this time, the temperature sensor 1107a outputs temperature signals, for inspecting the direction deviation state of an ink droplet discharged from a nozzle corresponding to the heater 1301a, to the voltage follower 331. Note that terminal voltage VSS on the ground side of the temperature sensor 1107a is output to the voltage follower 332. The three other temperature sensors 1107b to 1107d are also controlled by similar switching devices. The output signal Vs2 of the voltage follower 332 and the output signal Vs1 of the voltage follower 331 are subjected to differential amplification by the differential amplifier 333, and output to a band-pass filter 1302 as signal Vdif representing voltage at both ends of the temperature sensor 1107.

The band-pass filter 1302 removes high-frequency noise from the signal Vdif, and also cuts low-frequency components through differential processing, and the resulting signal is output as signal VF. An inverting amplifier performs inversion amplification of the filter output signal VF and performs output thereof as signal Vinv. When the discharge state of the ink droplets is normal, a positive peak appears in the signal Vinv. Accordingly, the signal Vinv is compared with the threshold value voltage Vdth by a comparator 1307, and outputs signal CMP that goes to high level when the positive peak appears in the inverted signal VF.

Signal processing at the RS latch circuit 344 and the flip-flop circuit 345 is the same as that in the block diagram in FIG. 3 according to the first embodiment, and accordingly description will be omitted from the present embodiment. Note that the distance between the auxiliary heater and the ink interface is greater than the distance between the heaters and the ink interface, due to the auxiliary heater being provided in a lower layer from the temperature sensor. Accordingly, the heat generation density of the auxiliary heater 1110 needs to be higher than the heat generation density of the heaters 1101 and 1104 in order to cause simultaneous bubbling at the ink interface directly above the heaters 1101 and 1104 and the auxiliary heater 1110 by driving for discharging ink droplets.

Now, assuming that simultaneous bubbling occurs at the ink interface if the heat generation density Qs of the auxiliary heater is 1.2 times the heat generation density Qm of the heater, the heat generation density ratio κ2 is 1/1.2 from Expression (8). The heating length ratio r is 1, as illustrated in FIG. 11, and accordingly the sheet resistance ratio γ is 1.2 from Expression (9). Assuming that the material of the heater films and of the auxiliary heater film is the same, a sheet resistance ratio γ of 1.2 can be realized by the film thickness of the auxiliary heater being 1.2 times the film thickness of the heaters. If the film thickness is the same, a material of which the specific resistance of the auxiliary heater films is 1/1.2=0.83 times the specific resistance of the heater needs to be selected.

### OTHER EMBODIMENTS

Although the first to fourth embodiments have been described above, the present invention is not limited to the above-described values and forms. For example, one each of the temperature sensor and the auxiliary heater may be provided adjacent to the heater on either side thereof. Also, the positions at which two temperature sensors and two auxiliary heaters are provided may be on the short sides of the heater, instead of on the long sides thereof. Also, the number of nozzles per nozzle row is not limited to four, and may be 512, for example, and the number of nozzle rows itself may be a plurality of rows, instead of one row.

As described above, in a configuration of a nozzle provided in a recording element substrate, there conventionally is known a configuration in which a temperature sensor is provided on a lower layer from a heater. In such a configuration, even if the temperature sensor is brought closer to the heater through an electroconductive plug structure, the distance between the sensor and the ink is great to begin with, and there is a limit in improvement in sensitivity of the sensor regarding temperature change.

Accordingly, the present invention enables the temperature sensor to be closer to the ink interface, as compared to the conventional configuration in which the temperature sensor and the heater are formed of film in the same layer. Further, the temperature sensor is electrically isolated from the heater and disposed outside of the heater, and also an auxiliary heater for heating the temperature sensor is provided on a lower layer from the temperature sensor, whereby the temperature sensor is sufficiently heated. Accordingly, temperature change in conjunction with state change of ink following driving of the heater, such as falling of tailing, bubble collapsing and refilling, and so forth, can be detected with even higher sensitivity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-190538, filed on Nov. 8, 2023, which is hereby incorporated by reference wherein in its entirety.

What is claimed is:

1. A recording element substrate including a substrate and a channel-formation member, wherein
a liquid chamber configured to accommodate a liquid is formed between the substrate and the channel-formation member,
a discharge orifice configured to discharge the liquid accommodated in the liquid chamber is provided in the channel-formation member,
the substrate includes at least a first layer, and a second layer that is farther away from a face on which the liquid chamber is formed than the first layer,
a first heater configured to generate heat by application of a drive pulse, and to heat and discharge the liquid from the discharge orifice, and a temperature sensor that is disposed with at least a portion overlapping the liquid chamber in plan view, are provided in the first layer, and
a second heater that is disposed with at least a portion overlapping the temperature sensor in plan view is provided in the second layer.

2. The recording element substrate according to claim 1, wherein
the first heater and the temperature sensor provided in the first layer are disposed not overlapping each other in plan view.

3. The recording element substrate according to claim 2, wherein
the first layer is a layer that is formed by a protective film of an insulator being provided over the first heater and the temperature sensor.

4. The recording element substrate according to claim 1, wherein
the recording element substrate includes a plurality of the liquid chambers, and a plurality of the first heaters are provided to each of the plurality of the liquid chambers.

5. The recording element substrate according to claim 1, wherein
each liquid chamber is provided with a plurality of the temperature sensors.

6. The recording element substrate according to claim 5, wherein
a pair of temperature sensors are disposed substantially symmetrically across the first heater in plan view.

7. The recording element substrate according to claim 5, wherein
the recording element substrate includes a plurality of the second heaters corresponding to each of the plurality of temperature sensors, and
the plurality of second heaters are connected electrically in parallel or in series.

8. The recording element substrate according to claim 1, wherein
each liquid chamber is provided with a plurality of the first heaters, and
the plurality of first heaters are connected electrically in parallel or in series.

9. The recording element substrate according to claim 1, wherein
the second heater is provided to heat the temperature sensor, and a drive pulse that is electrically independent from a drive pulse applied to the first heater is applied to the second heater.

10. The recording element substrate according to claim 9, wherein
each liquid chamber is provided with a switching device configured to drive at least one of the first heaters, and a switching device configured to drive at least one of the second heaters.

11. The recording element substrate according to claim 1, wherein
the second heater is provided to heat the temperature sensor, and a drive pulse that is synchronized with a drive pulse applied to the first heater is applied to the second heater.

12. The recording element substrate according to claim 11, wherein
each liquid chamber is provided with a switching device configured to drive a configuration in which at least one of the first heaters and at least one of the second heaters are connected electrically in parallel.

13. The recording element substrate according to claim 1, wherein
the second heater is configured so as not to cause bubbling of the liquid accommodated in the liquid chamber.

14. The recording element substrate according to claim 1, wherein
each liquid chamber is provided with a plurality of the first heaters, substantially symmetrically with respect to the discharge orifice, and
the temperature sensor is disposed between the plurality of first heaters.

15. A recording head, comprising:
a recording element substrate including a substrate and a channel-formation member; and
a control unit configured to control driving of the recording element substrate;
wherein a liquid chamber configured to accommodate a liquid is formed between the substrate and the channel-formation member,
a discharge orifice configured to discharge the liquid accommodated in the liquid chamber is provided in the channel-formation member,
the substrate includes at least a first layer, and a second layer that is farther away from a face on which the liquid chamber is formed than the first layer,
a first heater configured to generate heat by application of a drive pulse, and to heat and discharge the liquid from the discharge orifice, and a temperature sensor that is disposed with at least a portion overlapping the liquid chamber in plan view, are provided in the first layer, and
a second heater that is disposed with at least a portion overlapping the temperature sensor in plan view is provided in the second layer.
